(19) United States
(12) Patent Application Publication
(10) Pub. No.: US 2025/0209888 A1
(43) Pub. Date: Jun. 26, 2025

(54) GAMING SYSTEM WITH CREDIT PRESERVATION MANAGEMENT

(71) Applicant: Aristocrat Technologies Australia Pty Limited, North Ryde (AU)

(72) Inventors: Andrew Wyllie, North Ryde NSW (AU); Alan Wong, West Pennant Hills NSW (AU)

(21) Appl. No.: 18/640,901

(22) Filed: Apr. 19, 2024

(30) Foreign Application Priority Data
Dec. 20, 2023 (AU) 2023285777

(51) Int. Cl. G07F 17/32

(52) U.S. Cl. CPC G07F 17/3244; G07F 17/3237; G07F 17/3269

(57) ABSTRACT

An electronic gaming system including a server including a database, an electronic gaming device, and a module is described. The module is configured to receive a player account identifier (ID) associated with a player account associated with the electronic gaming device and receive a player lock input. The module is further configured to determine that the player account is authorized to lock the electronic gaming device, cause the electronic gaming device to lock, and transmit a message to the server, the message including a credit amount at the electronic gaming device when the player lock input was received, the player account ID, and a device ID associated with the electronic gaming device wherein the server is configured to store a credit preservation record in the database upon receipt of the message, the credit preservation record including the credit amount, the player account ID, and the device ID.

### CROSS REFERENCE TO RELATED APPLICATIONS

This application claims the benefit of priority to Australia Patent Application No. 2023/285777, filed Dec. 20, 2023, the contents of which are hereby incorporated by reference herein in their entirety.

### FIELD

The present application relates to a credit preservation system for a gaming venue.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player (RTP=return to player) over the course of many plays or instances of the game. The RTP and randomness of the RNG are critical to ensuring the fairness of the games and are therefore highly regulated. Upon initiation of play, the RNG randomly determines a game outcome and symbols are then selected which correspond to that outcome. Notably, some games may include an element of skill on the part of the player and are therefore not entirely random.

Some EGMs are deployed in conjunction with player tracking systems, such as the OASIS® or System 7000® system manufactured by Aristocrat® Technologies, Inc with a player tracking interface deployed at the respective EGM, for example, in the form of a player marketing module or “console” to enable the player to enter a player loyalty card. Some player marketing modules enable a player to reserve an EGM while taking a break. In an example, a player presses a reserve button and then removes their player loyalty card. The EGM is then locked until the player reinserts their player loyalty card into the console or a console associated with a second EGM in which case the player tracking system transfers the credits to the second EGM.

### SUMMARY

In one aspect, an electronic gaming system is described. The electronic gaming system includes a server including a database, an electronic gaming device, and a player interface module associated with the electronic gaming device and in communication with the server. The player interface module is configured to receive a player account identifier (ID) associated with a player account associated with the electronic gaming device and receive a player lock input. The player interface module is further configured to determine that the player account is authorized to lock the electronic gaming device and, based upon the player account being authorized to lock the electronic gaming device, cause the electronic gaming device to lock and transmit a message to the server, the message including a credit amount at the electronic gaming device when the player lock input was received, the player account ID, and a device ID associated with the electronic gaming device wherein the server is configured to store a credit preservation record in the database upon receipt of the message, the credit preservation record including the credit amount, the player account ID, and the device ID.

In another aspect, at least one non-transitory computer-readable storage medium with instructions stored is described. The instructions, in response to execution by at least one processor, cause the at least one processor to receive a player account identifier (ID) associated with a player account associated with an electronic gaming device and receive a player lock input. The instructions further cause the at least one processor to identify that the player account is authorized to lock the electronic gaming device and, in response to the player account being authorized to lock the electronic gaming device, cause the electronic gaming device to lock and transmit a message to a server, the message including a credit amount at the electronic gaming device when the player lock input was received, the player account ID, and a device ID associated with the electronic gaming device wherein the server is configured to store a credit preservation record in a database upon receipt of the message, the credit preservation record including the credit amount, the player account ID, and the device ID.

In another aspect, a method of maintaining player accounts implemented by at least one processor in communication with at least one memory is described. The method includes receiving, by the at least one processor, a player account identifier (ID) associated with a player account associated with an electronic gaming device and receiving, by the at least one processor, a player lock input. The method also includes determining, by the at least one processor, that the player account is authorized to lock the electronic gaming device and causing, by the at least one processor, the electronic gaming device to lock. The method further includes transmitting, by the at least one processor, a message to a server, the message including a credit amount at the electronic gaming device when the player lock input was received, the player account ID, and a device ID associated with the electronic gaming device wherein the server is configured to store a credit preservation record in a database upon receipt of the message, the credit preservation record including the credit amount, the player account ID, and the device ID.

An example embodiment describes a credit preservation system for a gaming venue, the system including:
a central server having a credit preservation database;
a plurality of EGMs; and
a plurality of player interface modules associated with respective ones of the EGMs and in data communication with the central server, each player interface module configured to
   receive a player identifier of a player playing the EGM, and
   responsive to a valid player lock input, carry out a credit preservation process including (i) removing a current credit amount from the EGM (ii) locking the associated EGM from which the current credit amount is removed, and (iii) transmitting a credit preservation message to the central server, the credit preservation message including the value of the current credit amount, the player identifier, and a machine identifier of the EGM,
the central server configured to respond to receipt of the credit preservation message by creating a new credit preservation record in the database including the value of the current credit amount, the player identifier and the machine identifier of the EGM.

Another example embodiment describes a credit preservation system for a gaming venue, the system including:
a central server having a credit preservation database;
a plurality of EGMs; and
a plurality of player interface modules associated with respective ones of the EGMs and in data communication with the central server,
the central server configured to determine whether it is permitted to process a credit preservation request from a respective EGM based upon a number of EGMs a player associated with a player identifier is permitted to lock and a number of credit preservation records having a credit value corresponding to the player identifier, and
upon being permitted to process a credit preservation request, respond to receipt of a credit preservation message by creating a new credit preservation record in the database including the value of the current credit amount, the player identifier and the machine identifier of the EGM contained in the credit preservation message.

Another example embodiment describes a computer-implemented method of preserving credits in a system of a gaming venue, the system including a plurality of EGMs and a plurality of player interface modules associated with respective ones of the EGMs and in data communication with the central server, the method including:
receiving credit preservation messages from respective ones of the EGMs at a central server having a credit preservation database, each credit preservation message including a value of a credit amount removed from the EGM, a player identifier, and a machine identifier of the EGM,
processing, while a number of credit preservation records for a player is less than a defined number of allowable credit preservation record for the player, each credit preservation message by creating a new credit preservation record in the database including the value of the credit amount, the player identifier and the machine identifier of the EGM.

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIG. 3 is a block diagram showing a credit preservation system.

FIGS. 4A and 4B show a flow chart of a method of an embodiment.

FIG. 5 is a flow chart of an unlock method of an embodiment.

### DETAILED DESCRIPTION

In an example, embodiments are described where credit preservation records are opened in a credit preservation database of a central server when an electronic gaming machine (EGM) is locked. In some examples, at least some players are able to lock more than one EGM.

The technical problems addressed herein include at least one of: (i) inability of known systems to maintain player account details when incurring technical difficulties, such as power outages or data communication faults; (ii) a manual, costly, and labor-intensive process required by known systems to remove funds from a machine and search a player tracking database to identify the owner of the funds; and (iii) inability of known systems to implement player reservation of multiple machines.

The resulting technical effects and/or technical benefits achieved by this disclosure include at least one of: (i) ability to maintain player account details when incurring technical difficulties, such as power outages or data communication faults; (ii) replacing the manual, costly, and labor-intensive process required by known systems to remove funds from a machine and search a player tracking database to identify the owner of the funds with an automatic, computer-implemented process; and (iii) ability to implement player reservation of multiple machines.

Flaws and limitations of existing mechanisms for locking EGMs have been identified. For example, some existing EGMs are deployed in conjunction with player tracking systems with a player tracking interface deployed at the respective EGM in the form of a player marketing module or console to enable the player to enter a player loyalty card. Some player marketing modules enable a player to reserve an EGM while taking a break. In an example, a player presses a reserve button and then removes their player loyalty card. The EGM is then locked until the player reinserts their player loyalty card into the console or a console associated with a second EGM in which case the player tracking system transfers the credits to the second EGM.

In the above-described known arrangement, while the EGM is locked, the credit balance remains on the EGM. If there is a technical problem with either the EGM or the console, the credits can be lost or the association of the credits with a specific player account can be lost. For instance, a power outage may result in the console needing to be reset. The console reset may result in the EGM becoming unlocked (e.g., allowing another party to access the machine and consume the credits) or, if the machine remains locked, loss of the identity of the specific player account may occur.

Similarly, if an EGM fails, the RAM of the EGM may need to be cleared in order to reset the fault resulting in the loss of the credit balance.

It will be appreciated that the longer the reservation period, the greater the risk that funds will be lost.

In another example, data communication faults may occur. For example, a console of an EGM may go offline preventing the system from transferring funds to a second EGM. Or the data communication process for removing funds from the machine may fail. It will be appreciated that in the above arrangement, the player will not be present at the machine when a data communication fault occurs such that the player can't be asked to make a try again input or similar to overcome any transitory communication failure.

Typically, manual intervention is then required to remove the funds from the machine and search the player tracking database to identify the owner of the funds. Such a process is typically time-consuming due to regulatory requirements.

A further limitation of such a system is that it only allows a player to reserve a single EGM because when a player accesses a second EGM, the first EGM is automatically unlocked and the credits are transferred. It may be desirable to allow certain players to reserve more than one machine.

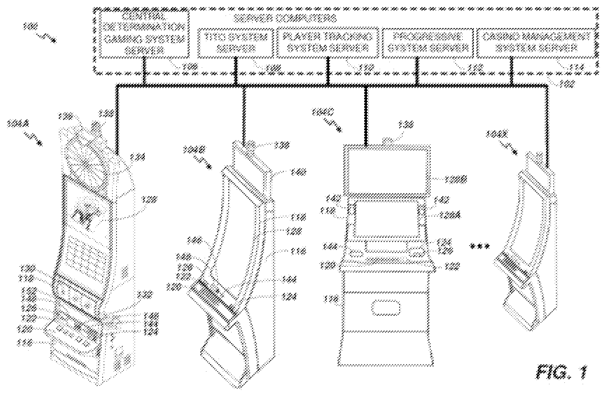

FIG. 1 illustrates several different models of EGMs which may be networked to various gaming related servers. The present embodiments can be configured to work as a system 100 in a gaming environment including one or more server computers 102 (e.g., slot servers of a casino) that are in communication, via a communications network, with one or more gaming devices 104A-104X (EGMs, slots, video poker, bingo machines, etc.). The gaming devices 104A-104X may alternatively be portable and/or remote gaming devices such as, but not limited to, a smart phone, a tablet, a laptop, or a game console.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, the present embodiments may, in one or more embodiments, be practiced on a stand-alone gaming device such as gaming device 104A, gaming device 104B or any of the other gaming devices 104C-104X. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket printer 126.

In FIG. 1, gaming device 104A is shown as a Relm XL™ model gaming device manufactured by Aristocrat® Technologies, Inc. As shown, gaming device 104A is a reel machine having a gaming display area 118 including a number (typically 3 or 5) of mechanical reels 130 with various symbols displayed on them. The reels 130 are independently spun and stopped to show a set of symbols within the gaming display area 118 which may be used to determine an outcome to the game. In embodiments where the reels are mechanical, mechanisms can be employed to implement greater functionality. For example, the boundaries of the gaming display area boundaries of the gaming display area 118 may be defined by one or more mechanical shutters controllable by a processor. The mechanical shutters may be controlled to open and close, to correspondingly reveal and conceal more or fewer symbol positions from the mechanical reels 130. For example, a top boundary of the gaming display area 118 may be raised by moving a corresponding mechanical shutter upwards to reveal an additional row of symbol positions on stopped mechanical reels. Further, a transparent or translucent display panel may be overlaid on the gaming display area 118 and controlled to override or supplement what is displayed on one or more of the mechanical reel(s).

In many configurations, the gaming device 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A. In some embodiments a ticket reader can be used which is only capable of reading tickets. In some embodiments, a different form of token can be used to store a cash value, such as a magnetic stripe card. In some other examples, a digital wallet can be used to store funds, such that funds can be transferred to and from the digital wallet. In some examples, an application on a user's mobile device (e.g. a cell phone) can communicate with the

In some embodiments, a player tracking card reader 144, and/or a transceiver for wireless communication with a player's smartphone (e.g. for communicating with loyalty application or digital wallet application on the player's smartphone. In some embodiments, a keypad 146, and/or an illuminated display 148 for reading, receiving, entering, and/or displaying player tracking information is provided in gaming device 104A. In such embodiments, a game controller within the gaming device 104A can communicate with the player tracking server system 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

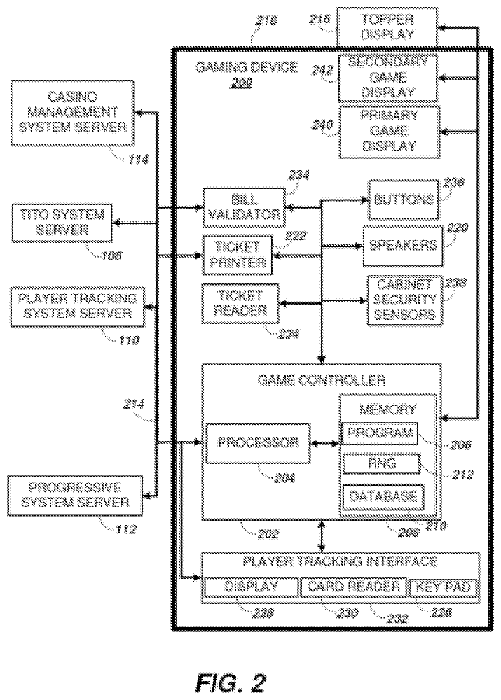

Many or all the above described components can be controlled by circuitry (e.g., a gaming controller) housed inside the main cabinet 116 of the gaming device 104A, the details of which are shown in FIG. 2.

Note that not all gaming devices suitable for implementing the present embodiments necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. The memory 208 may include one or more mass storage devices or media that are housed within gaming device 200. Within the mass storage devices and/or memory 208, one or more databases 210 may be provided for use by the program 206. A random number generator (RNG) 212 that can be implemented in hardware and/or software is typically used to generate random numbers that are used in the operation of game play to ensure that game play outcomes are random and meet regulations for a game of chance. In some embodiments, the random number generator 212 is a pseudo-random number generator.

Alternatively, a game instance (e.g., a play or round of the game) may be generated on a remote gaming device such as a central determination gaming system server 106 (not shown in FIG. 2 but see FIG. 1). The game instance is communicated to gaming device 200 via the network 214 and then displayed on gaming device 200. Gaming device 200 may execute game software, such as but not limited to video streaming software that allows the game to be displayed on gaming device 200. When a game is stored on gaming device 200, it may be loaded from a memory 208 (e.g., from a read only memory (ROM)) or from the central determination gaming system server 106 to memory 208. The memory 208 may include RAM, ROM or another form of storage media that stores instructions for execution by the processor 204.

The gaming device 200 may include a topper display 216 or another form of a top box (e.g., a topper wheel, a topper screen, etc.) which sits above main cabinet 218. The gaming cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. Ticket printer 222 may be used to print tickets for a TITO system server 108. The gaming device 200 may further include a bill validator 234, buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® or System 7000® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices, such as gaming devices 104A-104X, 200, are highly regulated to ensure fairness and, in many cases, gaming devices 104A-104X, 200 are operable to award monetary awards (e.g., typically dispensed in the form of a redeemable voucher). Therefore, to satisfy security and regulatory requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) the regulatory requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a credit input mechanism such as a coin acceptor (not shown) or bill validator 234 to establish a credit balance on the gamine machine. The credit balance is used by the player to place wagers on instances of the game and to receive credit awards based on the outcome of winning instances. The credit balance is decreased by the amount of each wager and increased upon a win. The player can add additional credits to the balance at any time. The credit balance may be stored in a meter in memory 208 (or in a separate hardware meter). In some embodiment, memory 208 implements a credit meter to monitor to the credit balance and has a win meter that monitors any amounts won during any game instance(s) resulting from the wager. The balance of the win meter is transferred to the credit meter prior at the conclusion of the game instances. The player may also optionally insert a loyalty club card into the card reader 230. In some embodiments, the loyalty club card may also act as a credit input mechanism, by allowing a player to transfer funds from a centrally stored balance in order to establish a credit balance. During the game, the player views the game outcome on the game displays 240, 242. Other game and prize information may also be displayed.

When the player is done, he/she cashes out the credit balance (typically by pressing a cash out button to receive a ticket from the ticket printer 222). The ticket may be “cashed-in” for money or inserted into another machine to establish a credit balance for play.

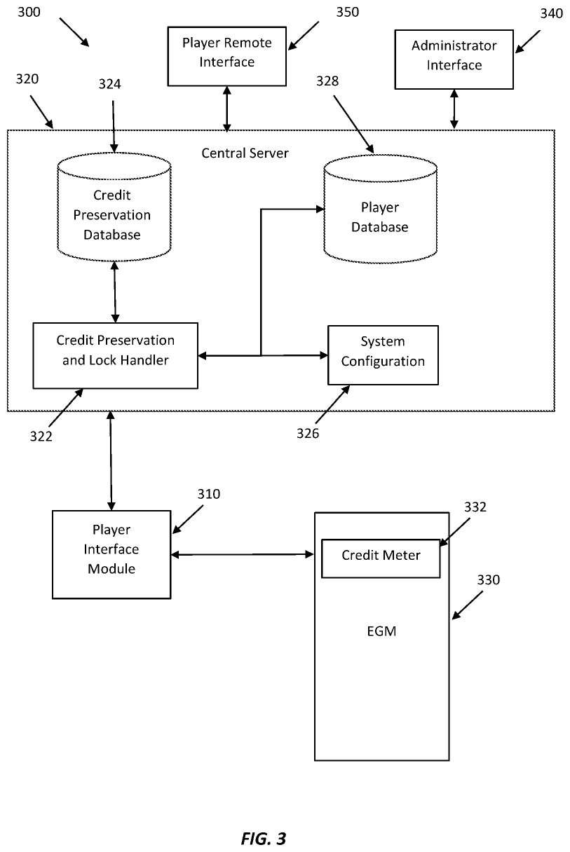

In the above examples, the player tracking interface and TITO interfaces are described as being part of the EGM. In other implementations, a player interface module, sometimes referred to as a console, is provided separately to the EGM to implement this functionality. For example, to enable EGMs of many different manufacturers and ages to be integrated to a common system such as Aristocrat's Oasis® or System 7000 system. Such consoles can have the visual appearance of being integrated with EGMs by being fitted within casings designed to fit to the EGMs to which they are connected. FIG. 3 is a block diagram illustrating such a system 300.

In FIG. 3, a player interface module 310 is separate to, but in data communication with each EGM 330 from which preservation requests can be received. The player interface module 310 has its own processor and a memory storing program code that governs operation of the player interface module. Player interface module 310 also incorporates a card reader for receiving a player card having a player identifier thereon and a ticket printer as described above. In other examples, player interface module may include a communication module (e.g., Bluetooth or NFC) for communicating with a user device (e.g., a cell phone or other mobile device) to obtain a player identifier. In other examples, other input devices such as a keyboard may be employed to receive a player identifier.

Central server 320 also includes one or more processors and memory storing program code that governs operation of the central server 320. Executing the code implements a credit preservation and handler 322 function on the server that handles credit preservation processes and locking processes as described in further detail below. Central server has a credit preservation database 324 for saving credit preservation records. An advantage of some embodiments of the invention is that more than one EGM can be locked by at one player. Depending on the implementation, central server has one or both of system configuration data 326 or a player database 328 that define user permissions including a number of EGMs that can be locked by individual players, groups of players, or classes of players. In some examples, player database 328 may be the player database of a player tracking/loyalty system. In some examples a number of EGMs that can be locked is set at a player level in the database. In another example, system configuration data 326 defines a number of EGMs that a player can lock based, for example, on classes of player loyalty. For example, gold loyalty members may be able to lock up to three machines, silver loyalty members up to two machines, and bronze loyalty members may be able to lock one machine.

One EGM 330 is shown in FIG. 3 for illustrative purposes but it will be appreciated that the EGM 330 will be one of a number of EGMs at a venue.

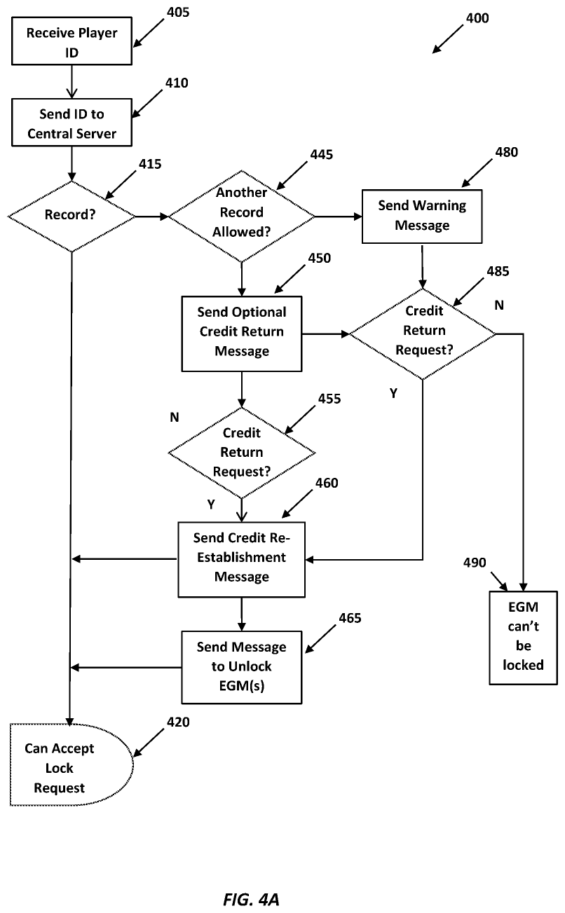

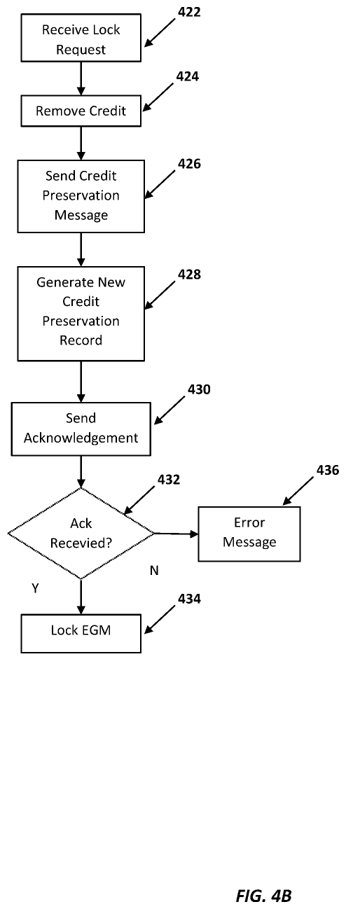

FIGS. 4A and 4B show a flow chart of an example embodiment of a method 400 of credit preservation in an example where a player identifier is received at a player interface module of an unlocked EGM. In this respect, it will be appreciated that when a player begins play of an EGM, it is possible that this is not a player's first interaction with an EGM at the venue. Accordingly, the method 400 takes into account that a credit preservation record may already exist for the player identifier of the player and also that, in some examples, individual players can lock more than one EGM.

Accordingly, the player interface module responds to receiving a player identifier at step 405 by sending 410 a player identifier received message to the central server 320 that includes the player identifier and a machine identifier of the EGM 330 with which the EGM is associated.

At step 415, the credit preservation and lock handler 322 of central server 320, checks the credit preservation database for an active credit preservation record associated with the player identifier and if it finds no record sends a return message to the EGM identified by the machine identifier that indicates that the EGM can be locked if a lock request is received. In other examples, where some players are not permitted to lock EGMs, credit preservation and lock handler 322 also checks whether the player identifier is associated with a player that has permission to lock at least one EGM based on the system configuration 326 and/or the player permission in player database 328.

Where credit preservation and lock handler 322 makes a negative determination at step 415, player interface module 310 is effectively in a waiting state 420 in which it can accept a lock request. The player interface module 310 remains in this state until it receives a lock request or it determines that the player corresponding to the player identifier had stopped playing the EGM 330—e.g. if a player removes a player card from the card reader, or if a player mobile device moves out of range of the communication module.

As shown in FIG. 4B, at step 422, player interface module 310 receives a lock request, At step 424, player interface module 310, removes the current credit balance from the credit meter 332 of the EGM. Then at step 426, player interface module sends a credit preservation message to the central server 320 containing the value of the current credit balance, the player identifier, and the machine identifier. Credit preservation and lock handler 322 responds to receipt of the credit preservation message by generating 428 a new record in the credit preservation database 324 that includes the value in currency of the credits, player identifier, and the machine identifier. Credit preservation and lock handler 322 also sends 430 an acknowledgement message to the player interface module 310 so that it can output a message on a display associated with the player interface module 310 confirming that the credits have been stored. In this way, should an error subsequently occur at the EGM or the player interface module, the credits are already safely stored. In an example, the player interface module 310 locks 434 the EGM 330 once the acknowledgement message is received. In some examples, the player interface module 310 locks EGM 330 for a defined time period—e.g., 30 minutes. In such examples, the EGM 330 is unlocked after the time period but the player can still redeem the funds stored in the credit preservation database 324, e.g. by providing their player identifier at an EGM.

In the case, where it is determined at step 432 that an acknowledgement message is not received (e.g., in a defined time), player interface module 310 outputs 436 an error message asking the player to retry the lock process. In other examples, player interface module 310 may take another or an additional action such as returning the credit value to the EGM or summoning an attendant. In this way, a player can advantageously be alerted to any error or address the error while they are still at the EGM 330.

As shown in FIG. 4A, in order to accommodate at least some players being able to lock more than one EGM, upon credit preservation and lock handler 322 making a positive determination at step 415 that a credit preservation record exists, at step 445 credit preservation and lock handler 322 determines whether the player is permitted to create another credit preservation record or put another way to lock another EGM. Upon making a positive determination at step 445, credit preservation and lock handler 322, returns 450 an optional credit return message that not only indicates that the player interface module 310 may lock the EGM but also contains details of the one or more current credit preservation records associated with the player identifier. This enables, the player interface module 310 to output a message on its display to indicate to the player that they have one or more current credit preservation records and enable the player to optionally request transfer of the value to the current EGM 330. For example, the player may be presented with the options to request transfer of funds associated with EGM A, EGM B, All EGMs, or no EGMs.

At step 455, the process involves determining whether the player has requested return of at least one of the one or more current credit preservation records. In an example, if a response is not received in a defined period or player enters a “no” response via player interface module 310, the player interface module 310 then enters the wait state 420 described above.

In cases where the player makes a request to redeem the funds, player interface module 310 sends a credit return request to central server 320, whereafter the credit preservation and lock handler 322, identifies the relevant credit preservation record, and sends 460 a credit re-establishment message to the relevant credit player interface module 310 including the value in currency and the player identifier whereafter the player interface module 310 adds credits to the EGM corresponding to the currency value. Credit preservation and lock handler 322 also sends 465 an unlock message to the player interface module(s) associated with the EGM(s) whose machine identifier is associated with the credit preservation record, whereafter that player interface module unlocks the relevant EGM.

If at step 445 credit preservation and lock handler 322, determines that the player cannot lock the current gaming machine, in one example, the credit preservation and lock handler 322 sends 480 a warning message to the player interface module 310. In an example, the warning message may indicate that the current EGM 330 cannot be locked and at step 490, the player interface module 310 enters a state where the associated EGM 330 can't be locked.

In another example, the warning message may indicate that the player needs to select an EGM to be unlocked and hence a credit preservation record to have its value transferred to a current EGM. In other examples, instead of a warning message, an automatic credit transfer process may be initiated, for example for players that can only lock one EGM.

If at step 485, player interface module 310 receives a request to return a credit, it sends a request to the credit preservation and lock handler 322, which then sends 460 a credit re-establishment message in order to return the currency value to the current EGM 330. Credit preservation and lock handler 322 marks the returned credit preservation record as inactive. Credit preservation and lock handler 322 also sends 465 an unlock message to the player interface module associated with the EGM identified by the machine identifier in the credit preservation record causing the relevant player interface module to unlock the EGM.

It will be appreciated that in other examples, the player interface module may only send a lock request message to the central server on an as needed basis. after receiving a request from the player to lock the EGM.

It will be appreciated that the above architecture and method enable a number of implementations when a player is identified by the central server 320 as being at an EGM 330 (e.g. when the player inserts a player card to the associated player interface module 310).

These include the central server providing the player interface with a list of credit preservation records (e.g., including records where a locked EGM has been unlocked because the defined lock period has ended).

In some examples, return of funds can be automatic. In other example, a player can choose which EGMs to unlock and transfer the credits to the current EGM. In some examples, the player has the option to: do nothing; transfer credits from an expired session (where EGM has been unlocked) to a current EGM; transfer credits from an active session to current EGM, leaving the previous EGM in a locked state; and/or transfer credits from an active session to a current EGM, releasing the previous EGM from the locked state.

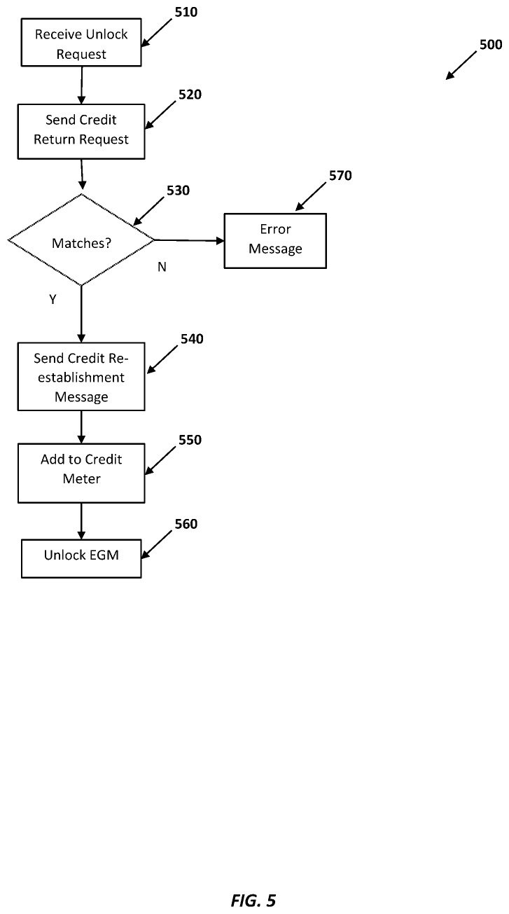

FIG. 5 illustrates an example unlock process 500. At step 510 player presents a player identifier to a player interface module 310 associated with an EGM 330 previously locked for the player and makes an unlock request such that the player interface module 310 receives an unlock request.

At step 520, player interface module 310 sends a credit return request message to the central server containing the player identifier and the relevant machine identifier.

At step 530, credit preservation and lock handler 322 processes the message and determines whether it matches a record in the credit preservation database 324. Upon making a positive determination, credit preservation and lock handler 322 sends 540 a credit re-establishment message to the player interface module that contains an amount in currency to be added to the associated EGM.

At step 550 player interface module 310 adds the amount to the credit meter 332 of the EGM 330 and then causes 560 the EGM 330 to unlock.

It will be appreciated that in other examples, the EGM 330 may be unlocked before credits are added to the credit meter 332 of the EGM 330. For example, there may be a first process where the player interface module 310 communicates with the central server 320 to determine whether the player is entitled to unlock the EGM 330 after which the EGM is unlocked and a second process for returning credits from the credit preservation record associated with the current EGM and/or other credit preservation records.

Should the request not match at step 530, credit preservation and lock handler 322 sends 570 an error to the player interface module 310 which controls an associated display to output the warning message.

As shown in FIG. 3, in an example, system 300 incorporates a remote player interface 350. In some examples, a player can access the remote player interface via a browser and/or a dedicated mobile device application in order to select one or more EGMs (e.g., an EGM have a specific game) to reserve and a time at which the respective EGM should be reserved. Credit preservation and lock handler 322 will then check whether the request is permitted based on the system configuration 326 and/or player permissions stored in player database 328. Upon the request being allowable, it is confirmed via the remote interface and the credit preservation and lock handler 322 will lock the relevant EGM shortly before the reserved time.

As shown in FIG. 3, in an example, system 300 incorporates an administrator interface 340. An employee of the venue may operate administrator database to reserve an EGM on behalf of a player.

The invention may also be said broadly to consist in the parts, elements and features referred to or indicated in the specification of the application, individually or collectively, in any or all combinations of two or more of said parts, elements or features.

Although the invention has been described by way of example, it should be appreciated that variations and modifications may be made without departing from the scope of the invention as defined in the claims. Furthermore, where known equivalents exist to specific features, such equivalents are incorporated as if specifically referred in this specification.

What is claimed is:

1. An electronic gaming system comprising:
a server comprising a database;
an electronic gaming device; and
a player interface module associated with the electronic gaming device and in communication with the server, wherein the player interface module is configured to:
receive a player account identifier (ID) associated with a player account associated with the electronic gaming device;
receive a player lock input;
determine that the player account is authorized to lock the electronic gaming device; and
based upon the player account being authorized to lock the electronic gaming device:
cause the electronic gaming device to lock; and
transmit a message to the server, the message comprising a credit amount at the electronic gaming device when the player lock input was received, the player account ID, and a device ID associated with the electronic gaming device, wherein the server is configured to store a credit preservation record in the database upon receipt of the message, the credit preservation record comprising the credit amount, the player account ID, and the device ID.

2. The electronic gaming system of claim 1, wherein the player interface module is further configured to:
receive a player unlock input; and
verify that the player unlock input corresponds to the player account ID that was utilized to lock the electronic gaming device.

3. The electronic gaming system of claim 2, wherein the player interface module is further configured to, based upon verifying that the player unlock input corresponds to the player account ID:
transmit a credit retrieval message to the server, the credit retrieval message comprising the player account ID and the device ID;
receive a credit return message from the server, the credit return message comprising the credit amount; and
cause the credit amount to be applied to the electronic gaming device.

4. The electronic gaming system of claim 3, wherein the server is configured to:
identify the credit preservation record corresponding to the credit retrieval message based on the player account ID and the device ID;
transmit the credit return message; and
update the credit preservation record to reflect return of the credit amount to the electronic gaming device.

5. The electronic gaming system of claim 1, wherein the player interface module is further configured to determine that the player account is authorized to lock the electronic gaming device by:
transmitting a lock query message to the server; and
receiving a lock answer message from the server, wherein the lock answer message indicates that the player account is authorized to lock the electronic gaming device.

6. The electronic gaming system of claim 1, wherein the server is configured to determine that the player account is authorized to lock the electronic gaming device by determining that locking the electronic gaming device would not exceed a defined number of locked electronic gaming devices associated with the player account.

7. The electronic gaming system of claim 1, wherein the player interface module is further configured to:
based upon receiving the player account ID, transmit a player account message to the server, the player account message including the player account ID; and
receive a player account response message from the server, the player account response message indicating that no current credit preservation record associated with the player account ID is stored in the database.

8. At least one non-transitory computer-readable storage medium with instructions stored thereon that, in response to execution by at least one processor, cause the at least one processor to:
receive a player account identifier (ID) associated with a player account associated with an electronic gaming device;
receive a player lock input;
identify that the player account is authorized to lock the electronic gaming device; and
in response to the player account being authorized to lock the electronic gaming device:
cause the electronic gaming device to lock; and
transmit a message to a server, the message comprising a credit amount at the electronic gaming device when the player lock input was received, the player account ID, and a device ID associated with the electronic gaming device, wherein the server is configured to store a credit preservation record in a database upon receipt of the message, the credit preservation record comprising the credit amount, the player account ID, and the device ID.

9. The at least one non-transitory computer-readable storage medium of claim 8, wherein the instructions further cause the at least one processor to:
receive a player unlock input; and
confirm that the player unlock input corresponds to the player account ID that was utilized to lock the electronic gaming device.

10. The at least one non-transitory computer-readable storage medium of claim 9, wherein the instructions further cause the at least one processor to, based upon confirming that the player unlock input corresponds to the player account ID, transmit a credit retrieval message to the server, the credit retrieval message comprising the player account ID and the device ID.

11. The at least one non-transitory computer-readable storage medium of claim 10, wherein the instructions further cause the at least one processor to:
receive a credit return message from the server, the credit return message comprising the credit amount; and
cause the credit amount to be applied to the electronic gaming device.

12. The at least one non-transitory computer-readable storage medium of claim 8, wherein the instructions further cause the at least one processor to identify that the player account is authorized to lock the electronic gaming device by:
transmitting a lock query message to the server; and
receiving a lock answer message from the server, wherein the lock answer message indicates that the player account is authorized to lock the electronic gaming device.

13. The at least one non-transitory computer-readable storage medium of claim 8, wherein the instructions further cause the at least one processor to:
in response to receiving the player account ID, transmit a player account message to the server, the player account message including the player account ID; and
receive a player account response message from the server, the player account response message indicating that no current credit preservation record associated with the player account ID is stored in the database.

14. A method of maintaining player accounts implemented by at least one processor in communication with at least one memory, the method comprising:
receiving, by the at least one processor, a player account identifier (ID) associated with a player account associated with an electronic gaming device;
receiving, by the at least one processor, a player lock input;
determining, by the at least one processor, that the player account is authorized to lock the electronic gaming device;
causing, by the at least one processor, the electronic gaming device to lock; and
transmitting, by the at least one processor, a message to a server, the message comprising a credit amount at the electronic gaming device when the player lock input was received, the player account ID, and a device ID associated with the electronic gaming device, wherein the server is configured to store a credit preservation record in a database upon receipt of the message, the credit preservation record comprising the credit amount, the player account ID, and the device ID.

15. The method of claim 14, further comprising:
receiving, by the at least one processor, a player unlock input; and
verifying, by the at least one processor, that the player unlock input corresponds to the player account ID that was utilized to lock the electronic gaming device.

16. The method of claim 15, further comprising:
transmitting, by the at least one processor, a credit retrieval message to the server, the credit retrieval message comprising the player account ID and the device ID;
receiving, by the at least one processor, a credit return message from the server, the credit return message comprising the credit amount; and
causing, by the at least one processor, the credit amount to be applied to the electronic gaming device.

17. The method of claim 16, further comprising:
identifying, by the server, the credit preservation record corresponding to the credit retrieval message based on the player account ID and the device ID;
transmitting, by the server, the credit return message; and
updating, by the at least one processor, the credit preservation record to reflect return of the credit amount to the electronic gaming device.

18. The method of claim 14, further comprising determining that the player account is authorized to lock the electronic gaming device by:
transmitting, by the at least one processor, a lock query message to the server; and
receiving, by the at least one processor, a lock answer message from the server, wherein the lock answer message indicates that the player account is authorized to lock the electronic gaming device.

19. The method of claim 14, further comprising determining, by the at least one processor, that the player account is authorized to lock the electronic gaming device by the server determining and communicating to the at least one processor that locking the electronic gaming device would not exceed a defined number of locked electronic gaming devices associated with the player account.

20. The method of claim 14, further comprising:
transmitting, by the at least one processor, a player account message to the server, the player account message including the player account ID; and
receiving, by the at least one processor, a player account response message from the server, the player account response message indicating that no current credit preservation record associated with the player account ID is stored in the database.
